(19) United States
(12) Patent Application Publication
(10) Pub. No.: US 2019/0221803 A1
(43) Pub. Date: Jul. 18, 2019

(54) SAFETY MECHANISM FOR SEALED PACKAGES CONTAINING A BATTERY

(71) Applicant: Vital Connect Inc., San Jose, CA (US)

(72) Inventors: Tyler MOORE, San Jose, CA (US); Ian FELIX, San Jose, CA (US)

(21) Appl. No.: 16/248,998

(22) Filed: Jan. 16, 2019

Related U.S. Application Data
(60) Provisional application No. 62/618,350, filed on Jan. 17, 2018.

(51) Int. Cl. H01M 2/12

(52) U.S. Cl. CPC H01M 2/1229

(57) ABSTRACT

System and method for providing a safety mechanism for sealed packages are disclosed. The safety mechanism for sealed packages containing the battery includes a one-way degassing valve placed on the sealed package or container, wherein the one-way valve allows movement of gas from inside the sealed package to outside the sealed package and prevents air from outside the sealed package from entering.

### CROSS-REFERENCE TO RELATED APPLICATIONS

Under 35 USC 119(e), this application claims priority to U.S. provisional application Ser. No. 62/618,350, entitled “SAFETY MECHANISM FOR SEALED PACKAGES CONTAINING BATTERY”, filed on Jan. 17, 2018.

### FIELD OF THE INVENTION

The present invention relates to a safety mechanism for sealed packages, and more particularly, to a safety mechanism for sealed packages containing battery.

### BACKGROUND

Sealed packages are used to store and transport electronic devices including medical devices containing batteries. Gas may build up inside a sealed package or container containing a battery leading to inflation or bursting. Therefore, there is a strong need for a solution that overcomes the aforementioned issues. The present invention addresses such a need.

### SUMMARY OF THE INVENTION

In an embodiment, a system comprising a safety mechanism for sealed packages containing a battery is disclosed. The safety mechanism for sealed packages containing the battery includes a one-way degassing valve placed on the sealed package or container.

### BRIEF DESCRIPTION OF THE DRAWINGS

The accompanying figures illustrate several embodiments of the invention and, together with the description, serve to explain the principles of the invention. One of ordinary skill in the art readily recognizes that the embodiments illustrated in the figures are merely exemplary, and are not intended to limit the scope of the present invention.

FIG. 1 illustrates a system comprising a safety mechanism for sealed packages containing a battery in accordance with an embodiment.

FIG. 2 illustrates a method for providing a safety mechanism for sealed packages containing a battery in accordance with an embodiment.

### DETAILED DESCRIPTION

The present invention relates to a safety mechanism for sealed packages, and more particularly, to a safety mechanism for sealed packages containing a battery. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

Sealed packages can be utilized for storing and transporting electronic devices containing a battery. A method and system in accordance with the present invention provides a safety mechanism for sealed packages containing battery including a one-way degassing valve placed on the sealed package or container. The use of the one-way degassing valve placed on the inside or outside of the sealed package or container allows for excess gas to escape without allowing air in. For example, in the case of a Zinc-air battery, should excess air enter the sealed package or container, battery life could become compromised, hindering product performance.

The use of a one-way degassing valve placed on the inside or outside of the package or container, allows for excess gas to escape without allowing air in. This prevents the package or container from bursting and prevents any external air from reaching the battery, thus providing a safety mechanism for sealed packages in storage and prevents activation of the battery.

To describe the features of the present invention in more detail, refer now to the following description in conjunction with the accompanying Figures.

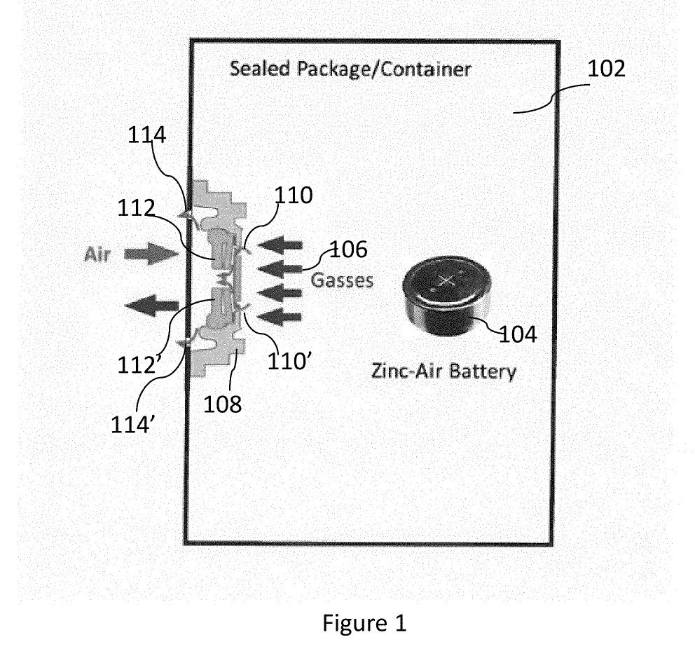

FIG. 1 illustrates a system comprising a safety mechanism for sealed packages containing batteries in accordance with an embodiment. The system includes a one-way valve 108 attached to a sealed package 102, wherein the one-way valve allows movement of gas 106 from inside the sealed package 102 to outside the sealed package 102.

The system may be particularly useful for packages containing electronic devices which include Zinc-air battery 104. Once the Zinc-air battery 104 is manufactured, a special material is put for example, in the form of a tab, on the Zinc-air battery 104. This special material has an allowance for oxygen transfer. With the “special material tab” on, just enough oxygen is allowed through so that the battery does not go through the self-destruct mode but not enough so that the battery is energized, as the zinc-air battery 104 needs air to energize. In the case of a Zinc-air battery 104, should excess air enter the sealed package or container 102, battery life could become compromised, hindering product performance. When the battery is used in the electronic devices, the “special material tab” is removed and the battery is placed in the electronic device, for example, a health-monitoring patch.

Occasionally, moisture may get into the battery 104 during assembly, and the battery 104 then may start to create hydrogen gas. If the battery 104 is then sealed within the pouch 102, this will result in forming a puffed pouch 102. This may cause the pouch 102 that contains the electronic device, for example, the patch, to burst, or expose the end-user to excess hydrogen gas. This may create a dangerous situation. In case of the sealed packages 102 containing an electronic device with a zinc-air battery, the material used for making the pouch 102, for example, may have the oxygen transfer level of the special material used in the “special material tab” discussed above. The person skilled in the art may readily recognize that other suitable materials for a particular purpose.

In one embodiment, the one-way degassing valve 108 is made of synthetic material, for example, plastic. The synthetic material may be non-reactive with the electronic device enclosed within the sealed package 102 and/or the gases 106 released by the electronic device enclosed within the sealed package 102. The thickness of the material may be such that the one-way degassing valve 108 stays flat on the sealed package 102, for example, 0.3 mm.

The one-way degassing valve 108 may be applied to the package 102 by using an adhesive material that may withstand a pre-determined pressure. For example, strength of the adhesive material may be such that it can withstand 0.1 psi or more of pressure exerted from the gases 106 released by the electronic device containing the battery 104 enclosed within the sealed package 102. In an embodiment, the one-way degassing valve may be applied to the package by using heat.

The one-way degassing valve 108 may release pressure by allowing the accumulated gases 106 to go out if the pressure inside the package rises above a certain pressure limit, for example, 0.1 psi or more, for example, 0.15 psi.

This use of one-way degassing valve 108 placed on the inside or outside of the sealed package or container 102 allows for excess gas to escape without allowing air in. For example, in the case of Zinc-air battery, should air enter the sealed package or container 102, battery life could become compromised, hindering product performance.

As illustrated in FIG. 1, the system may include one or more openings, e.g., 114, 114′, in the sealed package to allow the gasses go out from the package via the one-way valve. Although FIG. 1 illustrates a one-way valve attached to the inside of the sealed package containing a battery, it may be applied or attached to the outside of the sealed package containing a battery as discussed above.

In an embodiment, the one-way valve 108 comprises at least one opening 110 and/or 110′ that opens to the outside of the package 102. The one-way valve 108 may further include at least one flap 112 and/or 112′ that covers the opening that opens to the outside of the package 102.

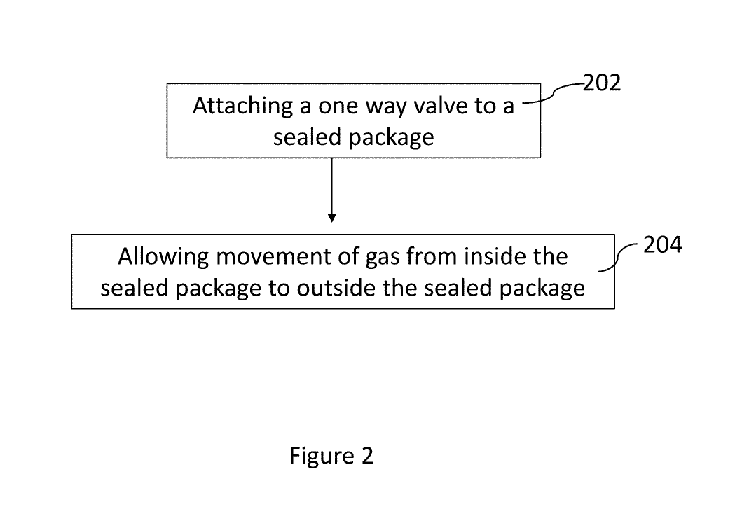

FIG. 2 illustrates a method for providing a safety mechanism for sealed packages containing battery in accordance with an embodiment using the system illustrated in FIG. 1 and described in the description accompanying FIG. 2. The method for providing a safety mechanism for a sealed package includes attaching a one-way valve to the sealed package via step 202, thereby allowing movement of gas from inside the sealed package to outside the sealed package via step 204.

The method may be particularly useful for packages containing electronic devices which include Zinc-air battery. Once the Zinc-air battery is manufactured, a special material is put for example, in the form of a tab, on the Zinc-air battery. This special material has an allowance for oxygen transfer. With the “special material tab” on, just enough oxygen is allowed through so that the battery doesn't go through the self-destruct mode but not enough so that the battery is energized, as the zinc-air battery needs air to energize. In the case of a Zinc-air battery, should excess air enter the sealed package or container, battery life could become compromised, hindering product performance. When the battery is used in the electronic devices, the “special material tab” is removed and the battery is placed in the electronic device, for example, a health monitoring patch.

Occasionally, moisture may get into the battery during assembly, and the battery then may start to create hydrogen gas. If the battery is then sealed within the pouch, this will result in forming a puffed pouch. This may cause the pouch that the electronic device, for example, the patch, is placed in to burst, or expose the end-user to excess hydrogen gas. This may create a dangerous situation. In case of the sealed packages containing an electronic device with a zinc-air battery, the material used for making the pouch may have the oxygen transfer level of the special material used in the “special material tab” as discussed above. The person skilled in the art may readily recognize that other suitable materials for a particular purpose.

In one embodiment, the one-way degassing valve is made of synthetic material, for example, plastic. The synthetic material may be non-reactive with the electronic device enclosed within the sealed package and/or the gases released by the electronic device enclosed within the sealed package. The thickness of the material may be such that the one-way degassing valve stays flat on the sealed package, for example, 0.3 mm.

The one-way degassing valve may be applied to the package via step 202 by using an adhesive material that may withstand a pre-determined pressure. For example, the strength of the adhesive material may be such that it can withstand 0.1 psi or more of pressure exerted from the gases released by the electronic device containing the battery enclosed within the sealed package. In an embodiment, the one-way degassing valve may be applied to the package by using heat.

The one-way degassing valve may release pressure by allowing the accumulated gases to go out via step 204 if the pressure inside the package rises above a certain pressure limit, for example, 0.1 psi or more, for example, 0.15 psi.

This use of one-way degassing valve, which may be placed on the inside or outside of the sealed package or container allows for excess gas to escape without allowing air in. For example, in the case of Zinc-air battery, should air enter the sealed package or container, battery life could become compromised, hindering product performance. The method further includes providing one or more openings in the sealed package for allowing movement of gas from inside the sealed package to outside the sealed package via the one-way valve.

In an embodiment, the one-way valve comprises at least one opening that opens to the outside of the package. The method may further include providing at least one flap that covers the opening of the one-valve that opens to the outside of the package. The presence of flap may allow the one-way valve to be closed until the pressure inside the sealed package reaches a pre-determined threshold as described above. For example, the one-way degassing valve may release pressure by allowing the accumulated gases to go out if the pressure inside the package rises above a certain pressure limit, for example, 0.1 psi or more, for example, 0.15 psi.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system for providing a safety mechanism for sealed packages, the system comprising:
a one-way valve attached to a sealed package that contains a battery, wherein the one-way valve allows movement of gas from inside the sealed package to outside the sealed package.

2. The system of claim 1, wherein the one-way valve is attached to the sealed package using adhesive material.

3. The system of claim 1, wherein the one-way valve is attached to the sealed package using heat.

4. The system of claim 1, wherein the system further comprises at least one opening that opens towards the outside of the package.

5. The system of claim 4, wherein the one-way valve further comprises a flap that covers the opening that opens towards the outside of the package.

6. The system of claim 1, wherein the one-way valve comprises material that is non-reactive to the gases released by the battery placed in the sealed package.

7. A method for providing a safety mechanism for a sealed package, the method comprising:
attaching a one-way valve to the sealed package that contains a battery;
wherein the one-way valve allows movement of gas from inside the sealed package to outside the sealed package.

8. The method of claim 7, wherein the one-way valve is attached to the sealed package using adhesive material.

9. The method of claim 7, wherein the one-way valve is attached to the sealed package using heat.

10. The method of claim 7, wherein the method further comprises providing at least one opening that opens towards the outside of the package.

11. The method of claim 10, wherein the method further comprises providing a flap that covers the opening of the one-way valve that opens towards the outside of the package.

12. The method of claim 7, wherein the one-way valve comprises material that is non-reactive to the gases released by the battery placed in the sealed package.
